(19) United States
(12) Patent Application Publication
(10) Pub. No.: US 2015/0032791 A1
(43) Pub. Date: Jan. 29, 2015

(54) METHOD AND APPLICATION FOR CONTROLLING APPLICATION SERVER INVOCATION IN AN IMS

(71) Applicant: FONAKTIEBOLAGET L M ERICSSON (PUBL), Stockhilm (SE)

(72) Inventors: Tobias Austrell, Alvsjo (SE); Timo Forsman, Sollentuna (SE); Annika Jonsson, Enskede (SE); Jan Tellinger, Hagersten (SE)

(73) Assignee: Telefonaktiebolaget L M Ericsson (publ) a corporation

(21) Appl. No.: 14/380,235

(22) PCT Filed: Feb. 24, 2012
(86) PCT No.: PCT/EP2012/053128

§ 371 Date: Sep. 5, 2014

(51) Int. Cl. H04L 29/08

(52) U.S. Cl. CPC H04L 67/10; H04L 67/306
USPC 709/201

(57) ABSTRACT

The present invention relates to a method for providing, to an S-CSCF, application server behaviour instructions. The application server behaviour instructions are applied by the S-CSCF when interworking with the application server that the instructions are for.

### TECHNICAL FIELD

The present invention relates to a method and application for controlling application server invocation in an IMS and, in particular, to a method of providing an S-CSCF with application server behaviour instructions to be applied by the S-CSCF when interworking with the specific application server.

### BACKGROUND

IP Multimedia Subsystems (IMS) provide a combination of voice, video, messaging, data, etc, within the same session. As the number of basic applications and the media which it is possible to combine increases, the number of services offered to the end users will grow, and the potential for enriching inter-personal communication experience will be improved. This leads to a new generation of personalised, rich multimedia communication services, including so-called “combinational IP Multimedia” services.

IMS is the technology defined by the Third Generation Partnership Project (3GPP) to provide IP Multimedia services over mobile and converged communication networks. IMS provides features to enhance the end-user person-to-person communication experience through the integration and interaction of services. IMS allows enhanced person-to-person (client-to-client) as well as person-to-content (client-to-server) communications over an IP-based network. The IMS makes use of the Session Initiation Protocol (SIP) to set up and control calls or sessions between user terminals (or user terminals and application servers). The Session Description Protocol (SDP) carried by SIP signalling is used to describe and negotiate the media components of the session. Whilst SIP was created as a user-to-user protocol, IMS allows operators and service providers to control user access to services and to charge users accordingly. Other protocols are used for media transmission and control, such as Real-time Transport Protocol and Real-time Transport Control Protocol (RTP/RTCP).

The components of an IMS 10 are illustrated in FIG. 1. Although only one copy of each component is illustrated in FIG. 1 it will be understood that the functions performed by each component may be executed by one or more devices which are distributed through one or more networks in any suitable manner.

Within the IMS 10 Call/Session Control Functions (CSCFs) operate as SIP proxies. The 3GPP architecture defines three types of CSCFs: the Proxy CSCF (P-CSCF) 12 which is the first point of contact within the IMS for a SIP terminal; the Serving CSCF (S-CSCF) 14, illustrated in more detail in FIG. 2, which provides session control and message routing functions; and the Interrogating CSCF (I-CSCF) 16 which is located at the edge of an administrative domain and acts as a contact point for connections to users associated with that domain. The P-CSCF 12 is located in the same network as the Gateway GPRS Support Node (GGSN) 18 which controls interworking between the GPRS network in which it is located and external networks.

Subscription-related information for users of the IMS is stored within a repository known as the Home Subscriber Server (HSS) 20 which is illustrated in more detail in FIG. 3. The HSS 20 includes an input 32 to receive user profile information and requests, an output 34 to transmit subscription-related information and other signals to the S-CSCF, a memory 36 to store the subscription-related information and a processor 38. The subscription-related information includes location information, security information (including authentication and authorization information), user profile information (including subscription service details) and the S-CSCF allocated to the user.

Finally, the IMS includes Application Servers (ASs) 22 which host and execute services and interface with the S-CSCF 14 to provide those services to users. In this specification the term Application Server is used to refer to a group of devices all of which are configured to provide the same functionality to an endpoint.

### SUMMARY

In accordance with an aspect of the present invention there is provided a Serving Call/Session Control Function (S-CSCF) in an IP Multimedia Subsystem (IMS). The S-CSCF includes an input to receive a user profile. The user profile includes, for an application server (AS), an AS behaviour instruction or an identifier for an AS behaviour instruction. The S-CSCF also includes a processor to apply the AS behaviour instruction when a service trigger for the AS is met. Thus, the interworking between the S-CSCF and an AS can be controlled, potentially on a per user or per group basis.

The S-CSCF may include a memory including an AS behaviour instruction associated with an identifier. In this instance when the IFC includes the identifier the processor references the memory and apply the AS behaviour instruction associated with the identifier. This helps to minimise the amount of bandwidth required to transmit the IFC including the behaviour instructions to the S-CSCF.

The S-CSCF memory may have an identifier associated with two or more AS behaviour instructions. The processor of such an S-CSCF applies every AS behaviour instruction associated with the identifier.

The S-CSCF may receive the AS behaviour instruction or the identifier in a Server Assignment Answer (SAA) message or in a Push Profile Request (PPR) message. Preferably the S-CSCF receives the AS behaviour instruction or identifier over a Cx interface.

The S-CSCF may store the AS behaviour instructions or identifier within the IFC of the user profile. This allows the AS behaviour instructions to be readily identified when the AS is invoked.

The AS behaviour instructions may include instructions on one or more of AS failover behaviour, AS selection behaviour, AS charging behaviour or AS dialogue behaviour.

The IFC may include a plurality of AS behaviour instructions and/or identifiers to more tightly define the interworking between the S-CSCF and the AS.

In accordance with a second aspect of the present invention there is provided a method in an IP Multimedia Subsystem (IMS) for regulating the interaction between a Serving Call/Session Control Function (S-CSCF) and an application server (AS). In the method the S-CSCF receives a user profile including, for an application server (AS), an AS behaviour instruction or an identifier for an AS behaviour instruction. The method includes the further step of the S-CSCF applying the AS behaviour instruction when a service trigger for the AS is met.

Optionally, the method includes the S-CSCF determining that the user profile includes an identifier for an AS behaviour instruction and the S-CSCF determining an AS behaviour instruction associated with the identifier. The step of applying the AS behaviour instruction involves applying the AS behaviour instruction associated with the identifier.

The unique identifier may be associated with two or more AS behaviour instructions. Where the unique identifier is associated with two or more AS behaviour instructions the step of applying the AS behaviour instruction involves applying every AS behaviour instruction associated with the unique identifier when a service trigger for the AS is met.

The method may further include the S-CSCF extracting the AS behaviour instruction or the identifier for an AS behaviour instruction from an Initial Filter Criteria (IFC) within the user profile.

In accordance with a third aspect of the present invention there is provided a computer-readable medium having computer-executable instructions for causing a Serving Call/Session Control Function (S-CSCF) in an IP Multimedia Subsystem (IMS) to perform the second aspect of the invention.

In accordance with a fourth aspect of the present invention there is provided a node in an IP Multimedia Subsystem (IMS). The node includes a memory configured to store a user profile. Within the user profile there is an AS behaviour instruction or an identifier for an AS behaviour instruction. The AS behaviour instruction is an instruction to a Serving Call/Session Control Function (S-CSCF) on how it should treat the AS when the AS is invoked.

The node preferably includes an output to transmit, in response to a request for all or part of a user profile, the one or more AS behaviour instructions or identifiers. The output may be, for example, a Cx interface.

The AS behaviour instruction or the identifier for an AS behaviour instruction stored within the node may be included within an Initial Filter Criteria (IFC) within the user profile.

The AS behaviour instructions optionally relate to instructions on one or more of AS failover behaviour, AS selection behaviour, AS charging behaviour and AS dialogue behaviour.

The node may be, for example, an HSS.

### BRIEF DESCRIPTION OF THE DRAWINGS

FIG. 1 illustrates an IMS architecture;

FIG. 2 illustrates an S-CSCF in an IMS;

FIG. 3 illustrates an HSS in an IMS;

FIG. 4 illustrates an Initial Filter Criteria of the present invention;

FIG. 5 is a flow diagram of an interaction between an S-CSCF and an HSS.

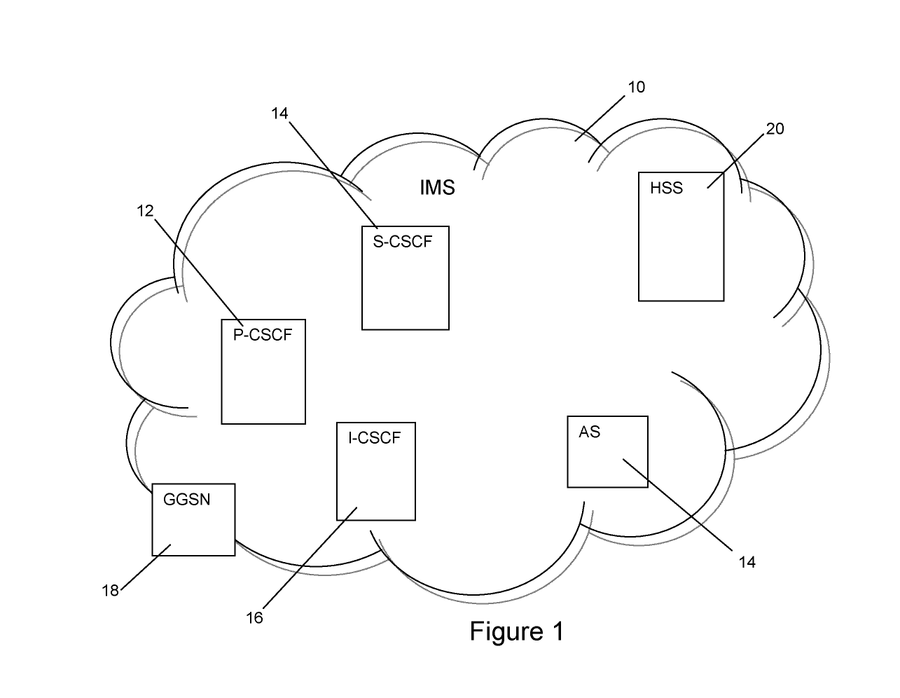

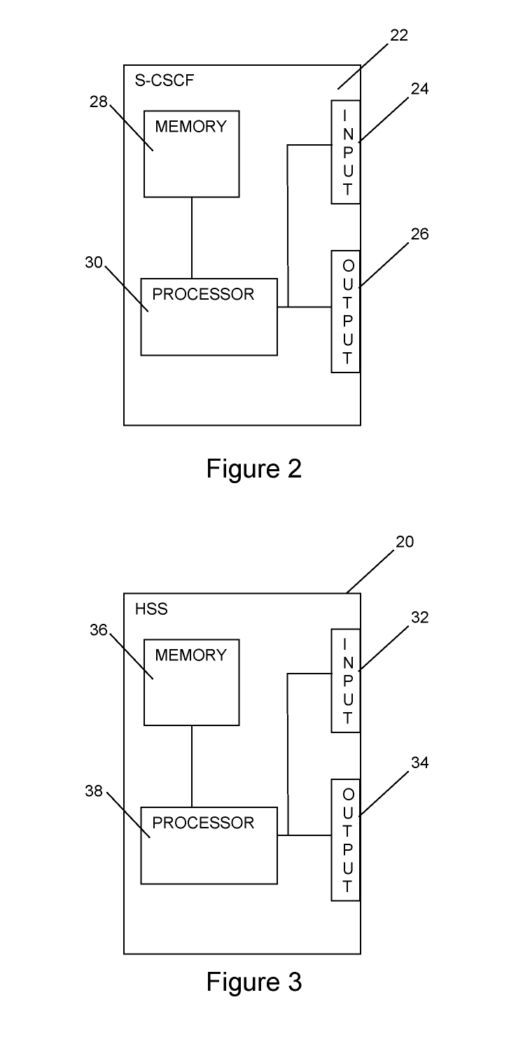

### DETAILED DESCRIPTION

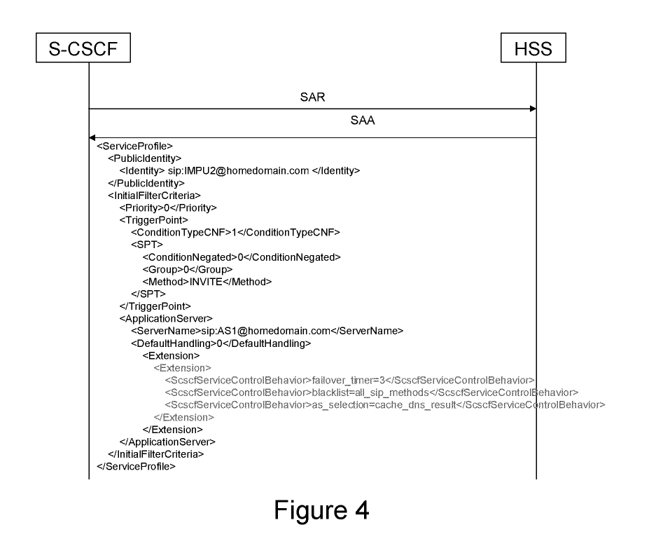

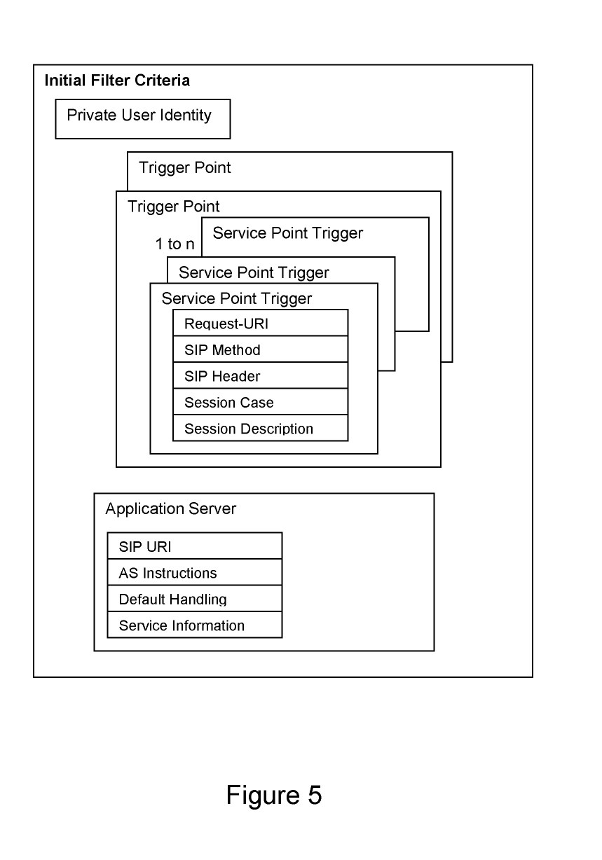

An example of the present invention will now be described with reference to FIGS. 4 and 5. During the process of registering an endpoint with the IMS the S-CSCF 14 selected to serve the endpoint will send, from its output 26, a Server-Assignment-Request (SAR) message to the user's home network's HSS to inform the HSS that the user is currently registered at that S-CSCF and request all or part of that user's profile. The HSS, in response to this message, will send the requested part of the user profile in the Server-Assignment-Answer (SAA) message.

The user profile in the SAA includes one or more Initial Filter Criteria (IFC) an example of which is illustrated in FIG. 5. The S-CSCF evaluates the IFC when the S-CSCF receives a request transmitted from or to the user endpoint to create a SIP dialog or receives message outside a SIP dialog.

As can be seen the IFC includes a priority which determines the order in which the S-CSCF assesses each of the IFCs associated with a user's service profile. It also includes a number of trigger points which determine whether a SIP request received by the S-CSCF is forwarded to an AS specified in the IFC. In the absence of any trigger points the request is unconditionally forwarded to the AS.

The IFC also contains the details of the AS that will handle the SIP request or message if the conditions specified in the trigger points are met. These details include the AS SIP URI and, optionally, a Default Handling field indicating the action to be taken if the S-CSCF cannot be contacted and/or a Service Information Field. The Service Information Field includes information that an AS may need to process a SIP REGISTER request, for example to enable the IMSI of the user to be passed to an IM-SSF (IP Multimedia Service Switching Function).

The IFC includes, in addition to the parameters described above, application server behaviour instructions to be used by the S-CSCF when interworking with the AS. These application server behaviour instructions may be one or more of an AS failover/fallback behaviour, AS selection behaviour, charging behaviour, dialogue behaviour, etc. . . .

The S-CSCF, upon receiving the SAA message at its input 24, stores the user profile, including the additional AS behaviour instructions in the IFC, in its memory 30.

When the S-CSCF receives a SIP request from an endpoint the processor 28 consults the user profile for the user endpoint in the memory and determines, in priority order, whether or not the trigger points for an AS are met. If the trigger point for an AS is not met then it proceeds to the next IFC. If the trigger points for the AS are met the S-CSCF consults the AS behaviour instructions included in the IFC for that AS and will interact with an AS apparatus as specified in the AS behaviour instructions.

For example, if the IFC is as illustrated in FIG. 4 the S-CSCF will determine that the failover time for the application server is 3 seconds, all SIP methods are blacklisted for that application server and the precise application server to provide the functions is selected using the DNS cache. Thus, in this example, if the selected application server apparatus does not respond to client requests forwarded by the S-CSCF within 3 seconds the S-CSCF will attempt to access a second application server apparatus which provides the same functionality as the selected application server apparatus.

In another embodiment of the invention the S-CSCF is provided with a table which is stored in the memory. The table contains unique identifiers that are associated with one or more application server behaviour instructions. For example the table may have the structure:

| Identifier | Behaviours |
|---|---|
| 1 | as_selection=cache_dns_result |
| 2 | blacklist=all_sip_methods |
| 3 | as_selection=cache_dns_result; |
| | blacklist=all_sip_messages |
| 4 | failover_timer=3 |
| . | |
| . | |
| . | |
| N | |

In this embodiment the IFC, rather than including the application server behaviour instructions as described above, includes one or more of the unique identifiers.

When the S-CSCF receives a SIP request from an endpoint it will consult the user profile identified in the request as described above. If a trigger for an AS is met then the S-CSCF will identify any application server behaviour instructions to be applied by consulting the table using the unique identifiers in the IFC.

Although the table of application server behaviour instructions is described as being maintained within the S-CSCF as will be understood by one skilled in the art the table may be provided within any node within the IMS, in particular it may be stored within the HSS.

Although the present invention has been described in relation to SAA messages, the skilled person will understand that any suitable message may send the application server behaviour instructions or associated identifier to the S-CSCF. In particular, the HSS may transmit IFCs including the application server behaviour instruction or identifier to the S-CSCF as part of a Push Profile Request (PPR) message sent by the HSS in response to a change in a user profile.

Additionally, although FIG. 4 illustrates the application server behaviour instructions being included as an extension to the application server information in the service profile it will be understood that the application server behaviour instructions or an associated identifier may be transmitted to the S-CSCF by the HSS using a DIAMETER AVP or in any other suitable way.

Optionally, the application server behaviour instruction may be included in any suitable part of the user profile and not the IFC provided that the application server behaviour instruction are linked to the application server such that whenever the application server is invoked the application server behaviour instructions act to control the interworking of the S-CSCF and the application server.

1. A Serving Call/Session Control Function (S-CSCF) in an IP Multimedia Subsystem (IMS) comprising:
an input to receive a user profile including, for an application server (AS), an AS behaviour instruction or an identifier for an AS behaviour instruction; and
a processor to apply the AS behaviour instruction when a service trigger for the AS is met.

2. The S-CSCF as claimed in claim 1 further comprising a memory including an AS behaviour instruction associated with an identifier and the processor is further configured, when the IFC includes the identifier, to reference the memory and apply the AS behaviour instruction associated with the identifier.

3. The S-CSCF as claimed in claim 2 wherein the identifier is associated with two or more AS behaviour instructions and the processor is configured to apply every AS behaviour instruction associated with the identifier.

4. The S-CSCF as claimed in claim 1 wherein the AS behaviour instruction or the identifier is received in a Server Assignment Answer (SAA) message or in a Push Profile Request (PPR) message.

5. The S-CSCF as claimed in claim 1 wherein the AS behaviour instructions or identifier is stored within the Initial Filter Criteria (IFC) of the user profile.

6. The S-CSCF as claimed in claim 1 wherein the input is a Cx interface.

7. The S-CSCF as claimed in claim 1 wherein the AS behaviour instructions comprise instructions on one or more of AS failover behaviour, AS selection behaviour, AS charging behaviour and AS dialogue behaviour.

8. The S-CSCF as claimed in claim 1 wherein the IFC includes a plurality of AS behaviour instructions and/or identifiers.

9. A method in an IP Multimedia Subsystem (IMS) for regulating the interaction between an Serving Call/Session Control Function (S-CSCF) and an application server (AS), the method comprising the steps of:
the S-CSCF receiving a user profile including, for an application server (AS), an AS behaviour instruction or an identifier for an AS behaviour instruction; and
the S-CSCF applying the AS behaviour instruction when a service trigger for the AS is met.

10. The method as claimed in claim 10 further comprising the steps of the S-CSCF determining that the user profile includes an identifier for an AS behaviour instruction and the S-CSCF determining an AS behaviour instruction associated with the identifier, and the step of applying the AS behaviour instruction comprises applying the AS behaviour instruction associated with the identifier.

11. The method as claimed in claim 11 wherein the unique identifier is associated with two or more AS behaviour instructions and the step of applying the AS behaviour instruction comprises applying every AS behaviour instruction associated with the unique identifier when a service trigger for the AS is met.

12. The method as claimed in claim 9 wherein the AS behaviour instruction or the identifier for an AS behaviour instruction is included within an Initial Filter Criteria (IFC) within the user profile.

13. The method as claimed in claim 9 wherein the AS behaviour instructions relate to instructions on one or more of AS failover behaviour, AS selection behaviour, AS charging behaviour and AS dialogue behaviour.

14. A computer-readable medium having computer-executable instructions for causing a Serving Call/Session Control Function (S-CSCF) in an IP Multimedia Subsystem (IMS) to perform the steps of claim 9.

15. A node in an IP Multimedia Subsystem (IMS) comprising:
a memory configured to store a user profile, the user profile including, for an application server (AS), an AS behaviour instruction or an identifier for an AS behaviour instruction, the AS behaviour instructions being instructions to a Serving Call/Session Control Function (S-CSCF) on how it should treat the AS when the AS is invoked.

16. A node as claimed in claim 15 further comprising an output to transmit, in response to a request for all or part of a user profile, the one or more AS behaviour instructions or identifiers.

17. A node as claimed in claim 16 wherein the output comprises a Cx interface.

18. A node as claimed in claim 15 wherein the AS behaviour instruction or the identifier for an AS behaviour instruction is included within an Initial Filter Criteria (IFC) within the user profile.

19. A node as claimed in claim 15 wherein the AS behaviour instructions relate to instructions on one or more of AS failover behaviour, AS selection behaviour, AS charging behaviour and AS dialogue behaviour.

20. A node as claimed in claim 15 wherein the node is an HSS.
